(19) United States
(12) Patent Application Publication
(10) Pub. No.: US 2025/0300798 A1
(43) Pub. Date: Sep. 25, 2025

(54) Link Flap Damping for Full-Duplex Link

(71) Applicant: Arista Networks, Inc., Santa Clara, CA (US)

(72) Inventors: Jonathan Chu, Sunnyvale, CA (US); Nathanael Dattappa, Milpitas, CA (US)

(21) Appl. No.: 18/613,520

(22) Filed: Mar. 22, 2024

(51) Int. Cl. H04L 5/14; H04L 41/0686

(52) U.S. Cl. CPC H04L 5/1461; H04L 41/0686

(57) ABSTRACT

A network device may be communicatively coupled to a remote device by a full-duplex communication link. The network device may perform link flap damping based on local and remote fault information and may signal, via a remote fault indication, a link flap damping state to the remote device.

### BACKGROUND

A networking system includes multiple network devices that are interconnected to form a network for conveying network traffic between host devices. Devices in the networking system can be connected via a wired communication link. In some instances, the wired communication link can be a full-duplex Ethernet link.

### BRIEF DESCRIPTION OF THE DRAWINGS

FIG. 1 is a diagram of an illustrative networking system having a network device communicatively coupled to another device in accordance with some embodiments.

FIG. 2 is a diagram of an illustrative network device in accordance with some embodiments.

FIG. 3 is a diagram of an illustrative network device configured to perform link flap damping for a full-duplex link in accordance with some embodiments.

FIG. 4 is a diagram of an illustrative network device configured to signal a damped link state for a full-duplex link to a remote device in accordance with some embodiments.

FIG. 5 is a diagram of an illustrative network device configured to obtain a penalty metric for link flap damping based on local and remote fault information in accordance with some embodiments.

FIG. 6 is an illustrative graph showing how a penalty metric for link flap damping changes over time based on local and remote fault information in accordance with some embodiments.

FIG. 7 is a flowchart of illustrative operations for performing link flap damping for a full-duplex link in accordance with some embodiments.

### DETAILED DESCRIPTION

A network can convey network traffic (e.g., in the form of packets, frames, etc.) between host devices or generally between devices in the network. To properly route and forward the network traffic, the network can include a number of network devices. A pair of devices (e.g., a pair of network devices, a pair of a network device and a host device, etc.) may be communicatively coupled to each other by a corresponding full-duplex communication link.

A network device in the device pair may perform link flap damping to mitigate the adverse effects associated with link flaps on the full-duplex communication link. In particular, the network device may associate a damped state with the full-duplex communication link, thereby causing (network) traffic not to be transmitted along a transmit path of the communication link to a remote device. It may be undesirable for the remote device to continue using a receive path of the communication link to transmit its (network) traffic for reception by the network device when the network device is not using the transmit path. Accordingly, the network device may signal an indication of the damped state (e.g., an indication of remote fault) on the transmit path, thereby causing the remote device to stop transmitting traffic on the receive path and causing the network device to stop receiving any traffic transmitted by the remote device.

To perform link flap damping, the network device may maintain (e.g., store and update) a metric as a measure of link flapping (e.g., indicative of a degree of link flapping or link flap occurrences). The metric is typically updated based on the link state of the communication link as a whole changing between up and down states. However, this approach of using the link state of the communication link as a whole to update the metric may lead to misrepresentations of the degree of link flapping, due to the full-duplex nature of the communication link (which has transmit and receive paths that can exhibit path states independent of each other). Accordingly, the network device may update the metric based on the transmit path state information and the receive path state information to better indicate the degree of link flapping. This advantageously provides more accurate timing for damping and undamping of the communication link, and consequently, improved signaling of the damped and undamped states of the communication link to the remote device.

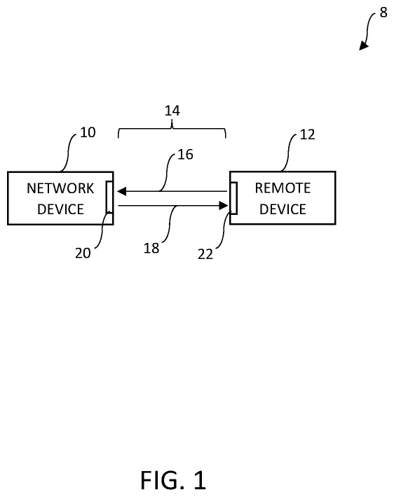

FIG. 1 is a diagram of an illustrative networking system in which one or more network devices are configured to perform link flap damping (e.g., in the manners described above). The networking system may include one or more components of a network such as network 8. Network 8 may have any suitable scope. As examples, network 8 may include, be, and/or form part of one or more local segments, one or more local subnets, one or more local area networks (LANs), one or more campus area networks, a wide area network, etc. In particular, network 8 may be a wired network based on wired technologies or standards such as Ethernet (e.g., using copper cables and/or fiber optic cables) and may optionally include a wireless network such as a wireless local area network (WLAN). If desired, network 8 may include internet service provider networks (e.g., the Internet) or other public service provider networks, private service provider networks (e.g., multiprotocol label switching (MPLS) networks), and/or any other types of networks such as telecommunication service provider networks.

Network 8 can include networking equipment forming a variety of network devices that interconnect and convey network traffic between end hosts (e.g., host devices) of network 8. These network devices such as network device 10 may each be a switch (e.g., a multi-layer (Layer 2 and Layer 3) switch or a single-layer (Layer 2) switch), a bridge, a router, a gateway, a hub, a repeater, a firewall, a wireless access point, a network device serving other networking functions, management equipment that manages and controls the operation of one or more of these network devices, or a network device that include the functionality of two or more of these devices.

Hosts (e.g., host devices or host equipment) of network 8 may include computers, servers, portable electronic devices such as cellular telephones and laptops, other types of specialized or general-purpose host computing equipment (e.g., running one or more client-side and/or server-side applications), network-connected appliances or devices that serve as input-output devices and/or computing devices in a distributed networking system, devices used by network administrators (sometimes referred to as administrator devices), network service or analysis devices, and/or management equipment that manages and controls the operation of one or more of other end hosts and/or network devices.

In the example of FIG. 1, network device 10 (sometimes referred to herein as the local network device from its own perspective) may be communicatively coupled via communication link 14 to another device 12 (sometimes referred to herein as a remote device from the perspective of the local network device 10). Remote device 12 may be another network device of network 8 or may be an end host of network 8 (e.g., a server or other types of host equipment).

Communication link 14 may be a physical connection between devices 10 and 12 formed using physical transmission media such as one or more cables (e.g., electrical cables or optical fiber cables). Communication link 14 may be a full-duplex link that includes one or more receive channels 16 (sometimes referred to herein as receive path(s) 16) and one or more transmit channels 18 (sometimes referred to herein as transmit path(s) 18). Embodiments described herein are often described from the perspective of network device 10, and as such, a given path or channel 16 is referred to as the receive path or channel of link 14 because data is received by network device 10 on path 16 (after being transmitted by remote device 12). Similarly, a given path or channel 18 is referred to as the transmit path or channel of link 14 because data is transmitted by network device 10 on path 18 (to be received by remote device 12). If desired, paths 16 and 18 may generally be referred to as the multiple paths or channels of link 14.

When connected using this full-duplex link 14, network device 10 may simultaneously and/or independently perform transmission and reception with respect to device 12. In other words, network device 10 may transmit traffic (e.g., network traffic conveyed across network 8) on one or more transmit paths 18 to remote device 12 while network device 10 receives traffic (e.g., network traffic conveyed across network 8) on one or more receive paths 16 from remote device 12. The one or more cables forming link 14 may be received and connected at corresponding physical port(s) 20 of network device 10 on one end and may be received and connected at corresponding physical port(s) 22 of remote device 12 on an opposite end. In configurations described herein as illustrative examples, communication link 14 may be an Ethernet link and ports 20 and 22 may be used to form Ethernet interfaces.

While shown separately from any other component(s) of network 8, devices 10 and 12 may be communicatively coupled to other network devices and/or host devices in network 8. As one illustrative example, devices 10 and 12 may be coupled between two portions of network 8, and network traffic conveyed between devices 10 and 12 using link 14 may be sourced from and destined for hosts in these network portions. This example is merely illustrative. If desired, other components of network 8 may be coupled to devices 10 and 12 based on any desired network configuration.

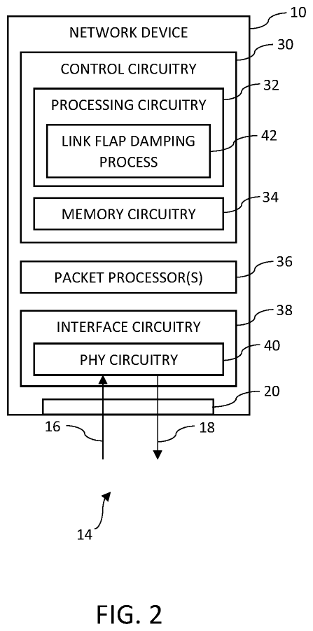

FIG. 2 is a diagram of an illustrative network device used to implement network device 10, device 12 (when implemented as a network device), and/or other network devices in network 8 in FIG. 1. Configurations in which the network device of FIG. 2 implements network device 10 in FIG. 1 are shown and described herein as an illustrative example.

As shown in FIG. 2, network device 10 may include control circuitry 30 having processing circuitry 32 and memory circuitry 34, one or more packet processors 36, and input-output interfaces formed using interface circuitry 38 and one or more ports 20. In one illustrative arrangement, network device 10 may be or form part of a modular network device system (e.g., a modular switch system having removably coupled modules usable to flexibly expand characteristics and capabilities of the modular switch system such as to increase ports, provide specialized functionalities, etc.). In another illustrative arrangement, network device 10 may be a fixed-configuration network device (e.g., a fixed-configuration switch having a fixed number of ports and/or a fixed hardware configuration).

Processing circuitry 32 of network device 10 may include one or more processors such as central processing units (CPUs), graphics processing units (GPUs), microprocessors, general-purpose processors, host processors, microcontrollers, digital signal processors, programmable logic devices such as field programmable gate array (FPGA) devices, application specific system processors (ASSPs), application specific integrated circuit (ASIC) processors, and/or other types of processors.

Processing circuitry 32 may run (e.g., execute) a network device operating system and/or other software/firmware that is stored on memory circuitry 34 communicatively coupled to and accessible by processing circuitry 32. Memory circuitry 34 may include one or more non-transitory (tangible) computer-readable storage media that store the operating system software and/or any other software code, sometimes referred to as program instructions, software, data, instructions, or code. As an example, the link flap damping operations described herein and performed by network device 10 may be stored as (software) instructions on the one or more non-transitory computer-readable storage media (e.g., in portion(s) of memory circuitry 34). The corresponding processing circuitry (e.g., one or more processors of processing circuitry 32) may process (e.g., execute) the respective instructions to perform the corresponding link flap damping operations. Memory circuitry 34 may include non-volatile memory (e.g., flash memory, electrically-programmable read-only memory, a solid-state drive, hard disk drive storage, etc.), volatile memory (e.g., static or dynamic random-access memory), removable storage devices (e.g., storage devices removably coupled to device 10), and/or other types of memory circuitry.

Processing circuitry 32 and memory circuitry 34 as described above may sometimes be referred to collectively as control circuitry 30 (e.g., implementing a control plane of network device 10). Accordingly, processing circuitry 32 may also sometimes be referred to as control plane processing circuitry 32. As just a few examples, processing circuitry 32 may execute network device control plane software such as operating system software, routing policy management software, routing protocol agents or processes, routing information base agents, and other control software, may be used to support the operation of protocol clients and/or servers (e.g., to form some or all of a communications protocol stack such as an Internet Protocol (IP) and Transmission Control Protocol (TCP) stack), may be used to support the operation of packet processor(s) 36, may store packet forwarding information, may execute packet processing software, and/or may execute other software instructions that control the functions of network device 10 and the other components therein.

Packet processor(s) 36 may be used to implement a data plane or forwarding plane of network device 10 and may therefore sometimes be referred to herein as data plane processor(s) 36 or data plane processing circuitry 36. Packet processor(s) 36 may include one or more processors such as programmable logic devices (e.g., field programmable gate array (FPGA) devices), application specific system processors (ASSPs), application specific integrated circuit (ASIC) processors, central processing units (CPUs), graphics processing units (GPUs), microprocessors, general-purpose processors, host processors, microcontrollers, digital signal processors, and/or other types of processors.

A packet processor 36 may receive incoming (ingress) network traffic via network interfaces implemented on ports 20 (and/or internal interfaces), parse and analyze the received network traffic, process the network traffic based on packet forwarding decision data (e.g., in a forwarding information base) and/or in accordance with network protocol(s) or other forwarding policy, and forward (or drop) the network traffic accordingly. The packet forwarding decision data may be stored on memory circuitry integrated as part of and/or separate from packet processor 36 (e.g., on content-addressable memory), and/or on a portion of memory circuitry 34. Memory circuitry for packet processor 36 may similarly include volatile memory and/or non-volatile memory.

Network device 10 may further include interface circuitry 38 configured to form the network interfaces using ports 20 (e.g., using physical lanes on port connectors of ports 20). In particular, interface circuitry 38 may include physical layer circuitry 40 (sometimes referred to herein as PHY circuitry 40), among other lower layer circuitry such as data link layer circuitry (e.g., a medium access control (MAC) sublayer). As an example, interface circuitry 38 may be implemented using one or more integrated circuits mounted to a printed circuit substrate and/or provided as part of a network interface controller, and/or using other types of network interface circuitry. Physical layer circuitry 40 may be formed from one of these integrated circuits that implements physical layer functions (e.g., as specified by the Open Systems Interconnection (OSI) model). Configurations in which physical layer circuitry 40 implements a physical layer portion of the Ethernet standard are sometimes described herein as an illustrative example. Accordingly, the combination of interface circuitry 38 and port 20 may provide the network (e.g., Ethernet) interfaces of network device 10 with which communication links such as full-duplex communication link 14 with remote device 12 (FIG. 1) can be established.

In some instances, ports 20 may be configured to directly receive electrical or optical cables used as the physical transmission media for communication link 14. In other instances, ports 20 may receive intervening module(s) (e.g., various types of small form-factor pluggable modules or generally removable transceiver modules) through which electrical or optical cables used as the physical transmission media for communication link 14 are received. In general, ports 20 may be physically coupled and electrically connected to corresponding mating connectors of external equipment, when received at the ports, and may have different form-factors to accommodate different cables, different modules, different devices, or generally different external equipment.

Communication link 14 may experience one or more link flaps, which are the undesired switching of a link state between a link up state (e.g., a link active or functional state) and a link down state (e.g., a link inactive or nonfunctional state), often occurring in rapid succession. If left unattended, the link flaps may cause excessive local processing as higher level (higher OSI layer) protocols such as routing protocols (e.g., Border Gateway Protocol (BGP)) executed by processing circuitry 32 continuously reconverge to incorporate the changing state of the link, and consequently, may also cause extra network traffic (e.g., in the form of route advertisements based on operations of the routing protocols). To mitigate these and/or other issues associated with link flaps, processing circuitry 32 may execute a link flap damping process 42 (e.g., as a separate process or as a (sub-) process to a routing protocol process such as a BGP process). The link flap damping operation performed by process 42 or generally by processing circuitry 32 as described herein may sometimes be referred to as a link flap dampening operation or generally as a link flap prevention or link flap protection operation.

Processing circuitry 32 may execute link flap damping process 42 (and/or routing protocol processes) by executing software instructions stored on memory circuitry 34. While link flap damping process 42 is sometimes described herein to perform respective parts of the link flap damping operation for link 14, this is merely illustrative. Processing circuitry 32 may be organized in any suitable manner (e.g., to execute any other agents or processes such as one or more routing protocols instead of or in addition to link flap damping process 42) to perform each part of the link flap damping operation. Accordingly, processing circuitry 32 (and/or control circuitry 32) may sometimes be described herein to perform the link flap damping operation instead of specifically referring to the one or more agents, processes, and/or kernel executed by processing circuitry 32.

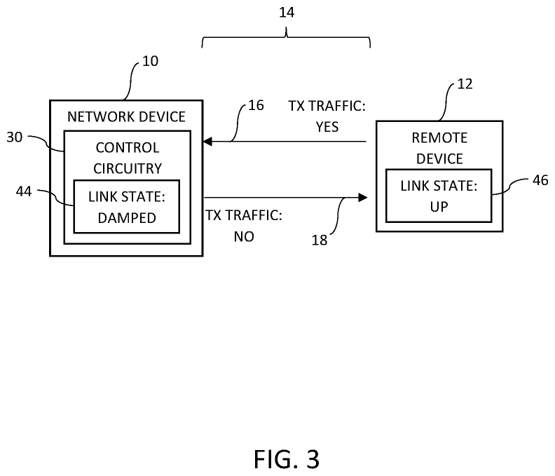

Processing circuitry 32 may generally perform the link flap damping operation (e.g., by executing link flap damping process 42) to smooth out (rapid) changes in link state associated with successive link flaps during a period of time by considering the link to be in a damped state (e.g., in an unusable or unstable state for the purposes of the routing or higher level protocols, sometimes referred to as a dampened state) during the period of time. While this may help mitigate link flap issues from the perspective of network device 10 (e.g., performing routing and forwarding functions), some issues with communication link 14 may arise, especially in the context of communication link 14 being a full-duplex communication link. These issues are illustrated by the example of FIG. 3.

As shown in FIG. 3, control circuitry 30 of network device 10 may maintain link state information such as link state 44 for full-duplex communication link 14 (e.g., on memory circuitry 34 in FIG. 2, as part of process 42 in FIG. 2, as part of a routing protocol process executing on processing circuitry 32 in FIG. 2, etc.). Link state 44 may contain an indication of whether or not link 14 is damped. In other words, when link 14 is damped (as determined by processing circuitry 32 executing link flap damping process 42), link state 44 may indicate that link 14 is in or generally associated with a damped state. While link 14 is not damped or undamped (as determined by processing circuitry 32 executing link flap damping process 42), link state 44 may indicate that that link 14 is in or generally associated with an undamped state.

In the example of FIG. 3, link state 44 for link 14 may be a damped state (e.g., as determined by processing circuitry 32 based on link flaps observed by physical layer circuitry 40). Based on link state 44 being a damped state, or effectively a (link) down state, processing circuitry 32 (executing one or more routing protocols) may route traffic away from link 14, e.g., by sending (BGP) route advertisement messages to peer network devices that do not advertise link 14, that actively withdraw use of link 14, etc. As network traffic is eventually diverted away from link 14, network device 10 may receive no network traffic to be transmitted using transmit path 18 of link 14 (e.g., causing idle control characters to be provided on path 18).

However, being unaware of network device 10 (e.g., processing circuitry 32) determining that link 14 is in a damped state, remote device 12 may still maintain link state information such as link state 46 for link 14 containing an indication that link 14 is up and functional (e.g., link state 46 being a link up state from the perspective of remote device 12). Accordingly, remote device 12 may still use path 16 of communication link 14 to transmit traffic for reception by network device 10. This causes link 14 to be a unidirectional link, which is undesirable, especially when the traffic conveyed with the unidirectional link uses protocols such as Transmission Control Protocol (TCP) that exhibit reliability properties (e.g., that rely on the return of acknowledgement messages indicative of the conveyed traffic being received). In particular, in this example, the return of acknowledgement messages will not be conveyed by link 18 in the damped state (e.g., may have to take a longer route, or may simply be dropped causing the conveyed traffic to be re-transmitted).

To mitigate these issues, network device 10 (e.g., control circuitry 30 using physical layer circuitry 40) may be configured to convey damped link state information to remote device 12. In particular, the conveyed damped link state information may be indicative of whether or not link 14 is being damped by processing circuitry 32 and/or whether the stored link state 44 for link 14 is a damped state or an undamped state.

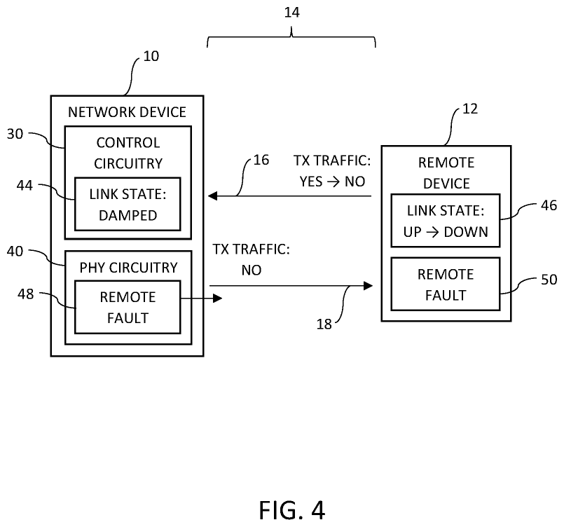

As shown in the example of FIG. 4, control circuitry 30 of network device 10, performing a link flap damping operation, may determine that link 14 should be damped (e.g., based on a frequency of link flaps causing a metric of link flapping to exceed an upper threshold). Accordingly, control circuitry 30 may update link state 44 for link 14 to a damped state. Based on link state 44 for link 14 being a damped state, control circuitry 30 may configure (e.g., send data and/or control signals to or otherwise control) physical layer circuitry 40 to convey (e.g., signal), to remote device 12 on transmit path 18, an indication of link 14 being damped by control circuitry 30 and/or link state 44 of link 14 being a damped state. In illustrative configurations described herein as an example, the conveyed indication of the damped link or damped link state may be an indication 48 of remote fault transmitted over path 18 to remote device 12. If desired, other indications or types of signaling may be used to convey the damped link or damped link state to remote device 12.

While link state 44 remains in a damped state, physical layer circuitry 40 may be configured to continually assert or signal indication 48 (e.g., corresponding characters associated with the remote fault), or if desired other indications, over path 18 to remote device 12. Based on receiving the indication of damped link or damped link state (e.g., transmitted indication 48 of remote fault), remote device 12 may store a received indication of damped link or damped link state (e.g., a received indication 50 of remote fault).

Accordingly, based on the signaling of the damped link or damped link state, remote device 12 may update its stored link state 46 for link 14 from a link up state to a link down state. In configurations where remote device 12 is configured to operate in accordance with the IEEE 802.3 standard, remote device 12 will be expected to update link state 46 for link 14 from a link up state to a link down state based on the signaling of a remote fault. As such, remote device 12 may also route (e.g. divert) traffic away from link 14 such that remote device 12 does not transmit network traffic using path 16 (e.g., idle control characters are provided on path 16) to network device 10.

When control circuitry 30, performing the link flap damping operation, determines that link 14 should no longer be damped (e.g., based on a lack of link flaps causing the metric of link flapping to decay past a lower threshold), control circuitry 30 may update link state 44 for link 14 to an undamped state (e.g., a link up state). Based on link state 44 for link 14 being an undamped state, control circuitry 30 may configure (e.g., send data and/or control signals to or otherwise control) physical layer circuitry 40 to stop conveyance of indication 48 of remote fault (or other indications of damped link or damped link state) on path 18 to remote device 12. In the absence of other faults, network device 10 (e.g., after control circuitry 30 advertises availability of link 14 based on routing protocol operations) may subsequently transmit network traffic on path 18 to remote device 12. Consequently, after remote device 12 stops receiving an indication of damped link or damped link state (and any other indications of faults), remote device 12 may revert back to the state shown in FIG. 3 to continue transmitting traffic on path 16 for reception by network device 10.

By considering transmit path 18 and receive path 16 of link 14 as separate paths, network device 10 may help facilitate symmetric behavior across link 14 (e.g., by remote device 12) even when remote device 12 itself does not have link flap damping capabilities (e.g., remote device 12 can rely on the reception of the remote fault indication or other indications of a link flap damp state resulting from network device 10 performing link flap damping). In other configurations, device 12 may also have link flap damping capabilities. In these other configurations, device 12 may operate as if it were network device 10 as described herein (e.g., signal to a peer device that the full-duplex link is damped from its perspective).

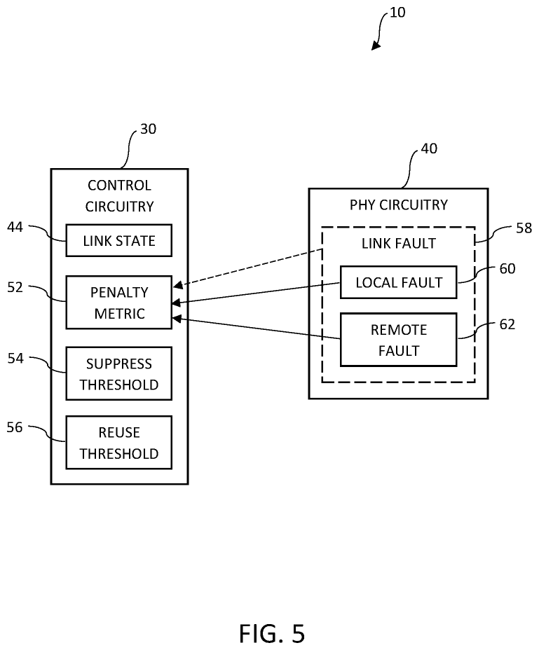

In illustrative embodiments described herein, control circuitry 30 may perform a more effective link flap damping operation by further considering transmit path 18 and receive path 16 separately. As shown in the example of FIG. 5, control circuitry 30, when performing a link flap damping operation (e.g., as part of executing process 42 on processing circuitry 32 in FIG. 2), may maintain a metric such as penalty metric 52 (e.g., with values of metric 52 varying over time). In particular, metric 52 may be maintained by storing metric 52 on memory circuitry 34 and updating values of metric 52 over time based on certain events. This metric may be an indication of the degree of link flapping on a particular full-duplex link (e.g., link 14). As an example, metric 52 may be a measure of, or based on, a frequency, a currency, a severity, and/or other characteristics of link flapping.

In particular, control circuitry 30, when performing the link flap damping operation, may use metric 52 to determine whether or not to damp (dampen) a particular full-duplex link such as link 14 in FIGS. 1-4, based on link flaps exhibited by the link and/or to determine whether or not to undamp (undampen) an already damped link based on (the lack of) link flaps exhibited by the link. In other words, control circuitry 30 may use metric 52 to determine (e.g., update) link state 44 (e.g., to a damped state or to an undamped or up state).

In illustrative configurations described herein as an example, control circuitry 30 may update (e.g., increment) metric 52 to have a higher (magnitude) value in response to link flap events (e.g., obtained by physical layer circuitry 40). Control circuitry 30 may update (e.g., continually decrease or decay in an exponential manner) metric 52 over time to have lower and lower (magnitude) values (in the absence of link flap events).

In this example, control circuitry 30 may maintain a suppress threshold 54 (e.g., on memory circuitry 34) which serves as an upper threshold for metric 52 and a reuse threshold 56 (e.g., on memory circuitry 34) which serves as a lower threshold for metric 52. In other words, when metric 52 exceeds (e.g., crosses to be above) suppress threshold 54, control circuitry 30 may damp the link (e.g., link 14) and update link state 44 to a damped state (e.g., as shown in FIG. 4). After metric 52 exceeds suppress threshold 54 and prior to metric 52 decaying past (e.g., exceeding) reuse threshold 56, control circuitry 30 may keep the link damped and keep link state 44 in the damped state. When metric 52 exceeds (e.g., crosses to be below) reuse threshold 56, control circuitry 30 may undamp the link and update link state 44 to an undamped or up state. In scenarios in which metric 52 exceeds (e.g., crosses to be below) reuse threshold 56 without previously exceeding (e.g., crossing to be above) suppress threshold 54, control circuitry 30 may keep the link undamped and keep link state 44 in an undamped or up state.

The above-described scheme for performing link flap damping based on metric 52 and thresholds 54 and 56 is merely illustrative. If desired, other schemes for performing link flap damping (e.g., where the value of metric 52 is decreased in response to link flap events, threshold 54 is a lower threshold, threshold 56 is an upper threshold, etc.) may be used, if desired. The embodiments described herein may similarly be applicable to these other schemes.

To facilitate the updating of metric 52, control circuitry 30 may typically obtain, from physical layer circuitry 40, general link fault information 58 that considers the link up and link down states of the entire link to update metric 52 (e.g., when a link flap is detected using link fault information 58, metric 52 is incremented). However, this approach has deficiencies in certain scenarios, such as when a local fault is exhibited on receive path 16 and detected by physical layer circuitry 40 while an indication of remote fault is received via path 16 from remote device 12, or more generally when there is interplay between obtained local and remote faults.

To further improve the link flap damping operation, control circuitry 30 (e.g., processing circuitry 32 in FIG. 2) may be configured to update the value of metric 52 using changes or updates in local fault (information) 60 observed or detected by physical layer circuitry 40 and using changes or updates in remote fault (information) 62 received by physical layer circuitry 40. In particular, control circuitry 30 (e.g., processing circuitry 32) may update (e.g., increment) the value of metric 52 in response to each occurrence (e.g., each assertion) of a local fault 60 detected by physical layer circuitry 40 based on observing a link flap of receive path 16. Control circuitry 30 (e.g., processing circuitry 32) may also update (e.g., increment) the value of metric 52 in response to each occurrence (e.g., each assertion) of a remote fault 62 transmitted by remote device 12 and received on receive path 16 by physical layer circuitry 40. The amount of increase in the metric value in response to an occurrence of local fault may be the same as or different than the amount of increase in the metric value in response to an occurrence of remote fault.

A local fault detected using physical layer circuitry 40 by observing the operation of receive path 16 may provide a (direct) indication of state information for receive path 16. In other words, receive path state information may include any link flaps observed on receive path 16 and flagged as corresponding occurrences of local fault by physical layer circuitry 40. A remote fault received by physical layer circuitry 40 on receive path 16 from remote device 12 (e.g., by remote device 12 signaling the indication for remote fault on receive path 16) may provide an (indirect) indication of state information for transmit path 18. In other words, transmit path state information may include (be indicative of) any link flaps observed by (or local faults detected by) remote device 12 on transmit path 18, which is then signaled to physical layer circuitry 40 on receive path 16 by remote device 12.

In such a manner, observed or detected local faults 60 and received remote faults 62 respectively provide receive path state information and transmit path state information based on which control circuitry 30 (e.g., processing circuitry 32 in FIG. 2) can update the value of metric 52. When updated in this manner, metric 52 may incorporate link flap information from the transmit path and the receive path separately, thereby providing a more accurate measure of link flapping on link 14.

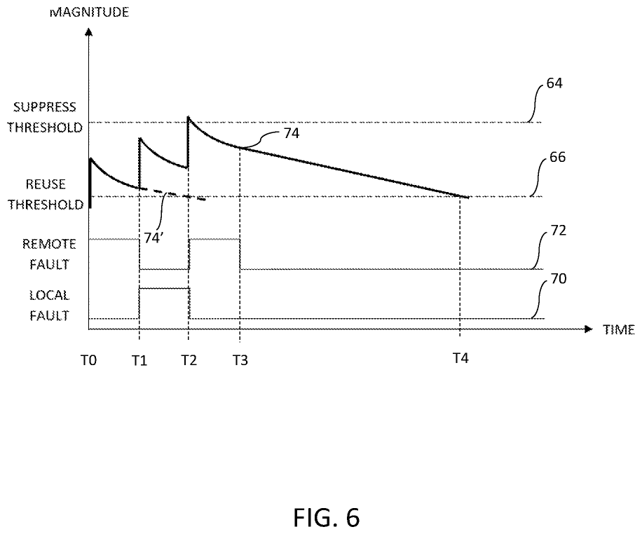

FIG. 6 is a graph showing illustrative changes in (the value of) a metric (e.g., metric 52 in FIG. 6), indicated by solid line 74, over time and in response to changes in the received remote fault information (indicated by line 72) and in response to changes in the observed local fault information (indicated by line 70).

When operating in the manner described in connection with FIG. 5, processing circuitry 28 (FIG. 2), when performing a link flap damping operation, may update the (magnitude) value of the metric over time to follow line 74 in response to the events shown in the example of FIG. 6. As similarly described in connection with FIG. 5, processing circuitry 28 may use dashed suppress threshold line 64 and dashed reuse threshold line 66 to determine whether or not to damp and whether or not to undamp the link (e.g., link 14) associated with the metric.

In the example of FIG. 6, processing circuitry 28 may increase the value (e.g., magnitude) of line 74 at time TO, e.g., based on an assertion or occurrence of remote fault indicated by a rising edge of line 72 at time TO. This assertion of remote fault may be received by physical layer circuitry 40 (FIG. 2) on receive path 16 and signaled by remote device 12 to indicate state information of transmit path 18 (e.g., a local fault observed by remote device 12 on path 18 or path 18 being damped by remote device 12).

Between time T0 and time T1, processing circuitry 28 may decrease the value of line 74 (e.g., based on an exponential decay) because no new instances of faults were observed or received. Processing circuitry may further increase the value of line 74 at time T1, e.g., based on an assertion or occurrence of local fault indicated by a rising edge of line 70 at time T1. This assertion of local fault may be directly observed by physical layer circuitry 40 on receive path 16 as a disruption in the signal received via receive path 16 (e.g., a disruption in the indication of remote fault transmitted by remote device 12 on receive path 16 starting at time TO). As shown in the example of FIG. 6, this causes the indication of remote fault not to be received by physical layer circuitry 40 between time T1 and time T2.

Between time T1 and time T2, processing circuitry 28 may again decrease the value of line 74 (e.g., based on an exponential decay) because no new instances of faults were observed or received. Processing circuitry may further increase the value of line 74 at time T2, e.g., based on an assertion or occurrence of remote fault indicated by a rising edge of line 72 at time T2. This assertion of remote fault may be received by physical layer circuitry 40 (FIG. 2) on receive path 16 and signaled by remote device 12 to indicate state information of transmit path 18 (e.g., a local fault observed by remote device 12 on path 18 or path 18 being damped by remote device 12).

At time T2, the maintained value of line 74 may exceed suppress threshold line 64. Accordingly, based on determining that line 74 (e.g., the metric) is above suppress threshold line 64, processing circuitry 28 may damp the link associated with the metric and update the corresponding state of the link to a damped state.

From time T2 onward, processing circuitry 28 may decrease the value of line 74 (e.g., based on an exponential decay) until a floor value for the metric is reached (e.g., beyond the timeline shown in FIG. 6) and line 74 is maintained at the floor value. At time T4, the maintained value of line 74 may exceed (e.g., decay past) reuse threshold line 66. Accordingly, based on determining that line 74 (e.g., the metric) is below reuse threshold line 64, processing circuitry 28 may undamp the link associated with the metric and update the corresponding state of the link to an undamped or up state.

When operated in the manner described in connection with FIG. 4, control circuitry 30 (e.g., processing circuitry 28), when performing the link flap damping operation, may also control physical layer circuitry 40 to signal an indication of damped link or damped link state (e.g., an indication of remote fault) at time T2 to remote device 12, to continue signaling the indication to remote device 12 until time T4, and to stop signaling the indication to remote device 12 at time T4.

The illustrative occurrences of received remote faults and the observed local fault shown in FIG. 6 may be caused by a remote device damping the link at time T0 and keeping the link damped until time T3. At time T1, a local fault may be detected based on a link flap on the receive path of the link that causes a disruption to the reception of the remote fault (shown as a lack of received remote fault between time T1 and time T2).

If the general link state information (e.g., information 58 in FIG. 5 simply indicating the up or down state of the entire link) is used, processing circuitry 28 would have updated penalty metric in a manner that follows dashed line 74′ because the link state remains down from the perspective of the entire link throughout the time period between time T0 to time T3. This may be undesirable as the metric (indicated by dashed line 74′) is not increased at time T1 and at time T2, thereby failing to account for at least two occurrences of link flaps at time T1 and time T2. This inaccuracy in the metric may further cause the link to be damped later than desired and/or undamp earlier than desired, leading to less effective link flap damping.

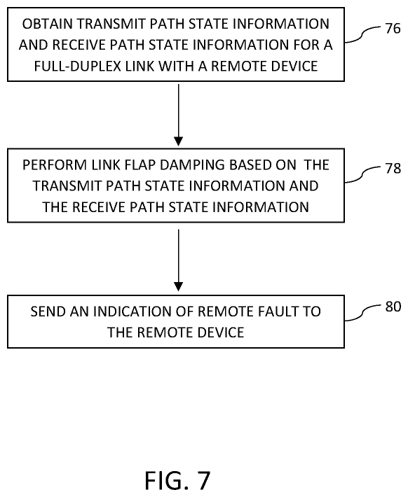

FIG. 7 is a flowchart of illustrative operations for performing link flap damping. These operations may be performed using one or more network devices in network 8 such as network device 10 as described in connection with FIGS. 1-6.

In configurations described herein as an illustrative example, the operations described in connection with FIG. 7 may be performed by control circuitry 30 in network device 10 (e.g., performed by processing circuitry 32 in network device 10 by executing software instructions stored on memory circuitry 34 in FIG. 2) and/or performed by interface circuitry 38 (e.g., performed using physical layer circuitry 40 in FIG. 2). If desired, one or more operations described in connection with FIG. 7 may be performed using other hardware components in network device 10.

At block 76, processing circuitry of a network device (e.g., processing circuitry 32 when executing link flap damping process 42 in FIG. 2) may obtain transmit path state information and receive path state information for a full-duplex link with a remote device. In particular, as described in connection with FIGS. 5 and 6, the processing circuitry may obtain, from physical layer circuitry of the network device, one or more instances of received remote faults (e.g., faults 62) signaled by remote peer device over a receive path of the full-duplex link as the transmit path state information. The processing circuitry may also obtain, from the physical layer circuitry, one or more instances of local faults observed on the receive path as the receive path state information.

At block 78, the processing circuitry may perform link flap damping based on the transmit path state information and the receive path state information. In particular, as described in connection with FIGS. 5 and 6, the processing circuitry may update the penalty metric based on occurrences of local fault (or other receive path state information) and based on occurrences of remote fault (or other transmit path state information).

At block 80, the processing circuitry may control the physical layer circuitry to send an indication of remote fault to the remote device. In particular, as described in connection with FIG. 4, the processing circuitry, based on damping the full-duplex link, may control the physical layer circuitry to send an indication of remote fault (or generally an indication of a damped link as determined by the processing circuitry) over a transmit path of the full-duplex link to the remote device. This may cause the remote device to stop transmission of (network) traffic on the receive path of the full-duplex link, thereby preventing the full-duplex link from being a unidirectional link.

The methods and operations described above in connection with FIGS. 1-7 may be performed by the components of a network device using software, firmware, and/or hardware (e.g., dedicated circuitry or hardware). Software code for performing these operations may be stored on one or more non-transitory computer readable storage media (e.g., tangible computer readable storage media) stored on one or more of the components of the network device. The software code may sometimes be referred to as software, data, instructions, program instructions, or code. The one or more non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of the network device (e.g., control plane processing circuitry 32 in FIG. 2, interface circuitry 38 of FIG. 2, etc.).

The foregoing is merely illustrative and various modifications can be made to the described embodiments. The foregoing embodiments may be implemented individually or in any combination.

What is claimed is:

1. A network device operable with a remote device, the network device comprising:
physical layer circuitry; and
control circuitry coupled to the physical layer circuitry and configured to:
store a link state for a full-duplex link with the remote device, the link state containing an indication of whether or not the full-duplex link is damped; and
control the physical layer circuitry to signal via a transmit path of the full-duplex link based on the indication of whether or not the full-duplex link is damped.

2. The network device defined in claim 1, wherein the control circuitry is configured to control the physical layer circuitry to transmit an indication of remote fault via the transmit path based on an indication of the full-duplex link being damped.

3. The network device defined in claim 2, wherein the transmission of the indication of remote fault, based on the indication that the full-duplex link is damped, causes the remote device to stop transmission of traffic on a receive path of the full-duplex link.

4. The network device defined in claim 2, wherein the control circuitry is configured to control the physical layer circuitry to stop transmission of the indication of remote fault via the transmit path based on an indication of the full-duplex link being not damped.

5. The network device defined in claim 1, wherein the control circuitry is configured to perform link flap damping to determine the link state for the full-duplex link.

6. The network device defined in claim 5, wherein the control circuitry is configured to maintain a metric indicative of a degree of link flapping and update the link state to contain an indication of the full-duplex link being damped based on the metric exceeding a first threshold.

7. The network device defined in claim 6, wherein the control circuitry is configured to update the link state to contain an indication of the full-duplex link being not damped based on the metric decaying past a second threshold.

8. The network device defined in claim 7, wherein the physical layer circuitry is configured to detect a local fault based on a signal disruption observed on a receive path of the full-duplex link and wherein the control circuitry is configured to maintain the metric by updating the metric based on the detected local fault.

9. The network device defined in claim 7, wherein the physical layer circuitry is configured to receive an indication of remote fault via a receive path of the full-duplex link and wherein the control circuitry is configured to maintain the metric by updating the metric based on the received indication of remote fault.

10. The network device defined in claim 1, wherein the control circuitry is configured to perform an operation in accordance with a routing protocol based on whether or not the full-duplex link is damped.

11. A network device comprising:
memory circuitry; and
one or more processors coupled to the memory circuitry and configured to:
obtain transmit path state information for a transmit path of a full-duplex link;
obtain receive path state information for a receive path of the full-duplex link; and
maintain a penalty metric for a link flap damping process based on the transmit path state information and based on the receive path state information.

12. The network device defined in claim 11, wherein the transmit path state information comprises remote fault information received via the receive path.

13. The network device defined in claim 12, wherein the one or more processors are configured to maintain the penalty metric by updating the penalty metric when the remote fault information indicates an occurrence of remote fault.

14. The network device defined in claim 11, wherein the receive path state information comprises local fault information generated based on the receive path.

15. The network device defined in claim 14, wherein the one or more processors are configured to maintain the penalty metric by updating the penalty metric when the local fault information indicates an occurrence of local fault.

16. The network device defined in claim 11, wherein the one or more processors are configured to maintain the penalty metric by increasing the penalty metric in response to one or more occurrences of fault at the transmit path or at the receive path and wherein the one or more processors are configured to associate a damped state with the full-duplex link based on the maintained penalty metric exceeding a threshold.

17. The network device defined in claim 16, wherein the one or more processors are configured to maintain the penalty metric by decreasing the penalty metric over time and wherein the one or more processors are configured to associate an undamped state with the full-duplex link based on the maintained penalty metric exceeding an additional threshold.

18. The network device defined in claim 16, wherein the one or more processors are configured to signal, using physical layer circuitry and on the transmit path, an indication of remote fault based on the full-duplex link being associated with the damped state.

19. A network device comprising:
physical layer circuitry; and
control circuitry coupled to the physical layer circuitry and configured to:
store a link state of a full-duplex link;
update the link state of the full-duplex link to a damped state; and
transmit, using the physical layer circuitry and on a transmit path of the full-duplex link, an indication of the damped state based on the link state being updated to the damped state.

20. The network device defined in claim 19, wherein the transmitted indication of the damped state comprises a transmitted indication of remote fault.
